(19) United States
(12) Patent Application Publication
(10) Pub. No.: US 2007/0218963 A1
(43) Pub. Date: Sep. 20, 2007

(54) Sliding apparatus and mobile phone having the same

(75) Inventor: Sam Jong Kim, Anyang-Si (KR)

Correspondence Address: Robert Popa, Esq.;c/o LADAS & PARRY, Suite 2100, 5670 Wilshire Boulevard, Los Angeles, CA, 90036-5679, US

(73) Assignee: DIABELL CO., LTD.

(21) Appl. No.: 11/410,570

(22) Filed: Apr. 24, 2006

(30) Foreign Application Priority Data
Mar. 14, 2006 (KR) 2006-23478

(51) Int. Cl. H04M 1/00

(52) U.S. Cl. 455/575.4

(57) ABSTRACT

A sliding apparatus for a mobile phone comprises a first slider, a second slider installed slidably on the first slider, and a pushing device between the first and second sliders to move the second slider towards one side of the first slider. The pushing device comprises a first push rod hingably coupled to one side of the first slider, a second push rod hingably coupled to the other side of the second slider, a guide member, one end of which is installed with the first push rod, and the other end of which is installed with the second push rod such that the first and second push rods slide on the guide member, and elastic members to support the push rods. External force applied to the sliding device is dispersed to the elastic members via the push rods, preventing deformation of the elastic members and degradation in performance.

### CROSS-REFERENCE TO RELATED APPLICATION

This application claims the benefit under 35 U.S.A. §119 of Korean Patent Application No. 2006-23478, filed on Mar. 14, 2006 in the Korean Intellectual Property Office, the disclosure of which is incorporated herein by reference.

### BACKGROUND OF THE INVENTION

1. Field of the Invention

The present invention relates to a sliding apparatus which allows two members installed thereon to slide along each other, and a mobile phone having the same. More particularly, the present invention relates to a sliding apparatus which can maintain stable operation even after long-term use thereof, and a mobile phone having the same.

2. Description of the Related Art

A sliding apparatus is an apparatus that is interposed between two members and allows the members to slide with respect to each other. The sliding apparatus comprises a first slider installed to one of the members and having a predetermined length, and a second slider installed to the other such that the second slider is able to slide with respect to the first slider. Such a sliding apparatus is applied to mobile phones and the like which are opened and closed in a sliding manner.

One of the conventional sliding apparatuses disclosed in Korean Utility-Model Registration Publication No. 20-0350313 comprises: a guide member mounted to an upper body and having a pair of guide rails; a slide member mounted to a lower body while being slidably installed to the guide member; and a pair of elastic members formed of torsion springs and positioned between the guide member and the slide member to allow the slide member to be semi-automatically slid.

With such a conventional sliding apparatus, when the upper body is pushed by a length about half of a maximum travel distance by a user, the guide member and the slide member are slid along each other by resilient force of the torsion springs so that the upper body travels semi-automatically the remaining length.

However, since the conventional sliding apparatus requires repetition of elastic deformation and elastic recovery of the torsion springs to move the sliding members, it has a problem in that, since the torsion springs are likely to be deformed due to long term use of the sliding apparatus, the behavior of the sliding apparatus becomes unstable.

### SUMMARY OF THE INVENTION

Accordingly, it is an aspect of the present invention to provide a sliding apparatus, which can suppress permanent deformation of elastic members even after long term use of the apparatus, and degradation in performance caused by the deformation, and a mobile phone having the same.

Additional aspects and/or advantages of the invention will be set forth in part in the description which follows and, in part, will be apparent from the description, or may be learned by practice of the invention.

The foregoing and other aspects of the present invention are achieved by providing a sliding apparatus, comprising a first slider having a predetermined length, a second slider installed slidably on the first slider to make linear movement in a longitudinal direction of the first slider, and a pushing device disposed between the first and second sliders to move the second slider towards one of both sides of the first slider depending on a location of the second slider, wherein the pushing device comprises a first push rod hingably coupled at one end to one side of the first slider in a widthwise direction, a second push rod hingably coupled at one end to the other side of the second slider in the widthwise direction, a guide member, one end of which is installed with the first push rod, and the other end of which is installed with the second push rod such that the first and second push rods can make linear movement on the guide member, and a plurality of elastic members installed in the guide member to resiliently support the first and second push rods, respectively.

The guide member may comprise a first guide part opened at one side of the guide member to allow the first push rod to be installed on the first guide part and linearly move along the one side of the guide member, and a second guide part opened at the other side of the guide member to allow the second push rod to be installed on the second guide part and linearly move on the other side of the guide member.

The first and second guide parts may have mouths, each being opened to have a relatively narrow width, and the other sides of the first and second push rods inserted into the first and second guide parts may have protrusions laterally protruding therefrom so as to be latched to the mouths of the first and second guide parts, respectively.

Each of the elastic members may be formed of a coil spring, and the other sides of the first and second push rods inserted into the first and second guide parts may have supports extending therefrom so as to be placed into the elastic members formed of the coil spring.

The other sides of the first and second push rods may be bifurcated into two branch-rods such that the supports are provided to the branch-rods, and allow the elastic members to be installed thereon, respectively.

The first push rod may be provided at one end with a first hinge hingably coupled to the first slider, and the second push rod may be provided at the other side with a second hinge hingably coupled to the second slider, the first hinge and the second hinge being disposed symmetrically on a line collinear with a central axis of the guide member.

The other sides of the first and second push rods may be bifurcated into two branch-rods, respectively, such that the branch-rods of the first push rod alternate with the branch-rods of the second push rod.

In accordance with another aspect of the present invention, there is provided a mobile phone, comprising: a first member having a display window provided thereon; a second member having key pads arranged thereon; a first slider having a predetermined length and being installed on the first member; a second slider installed on the second member while being slidable along the first slider in a longitudinal direction of the first slider; and a pushing device disposed between the first and second sliders to move the second slider towards one of both sides of the first slider depending on a location of the second slider, wherein the pushing device comprises a first push rod hingably coupled at one end to one side of the first slider in a widthwise direction, a second push rod hingably coupled at one end to the other side of the second slider in the widthwise direction, a guide member, one end of which is installed with the first push rod, and the other end of which is installed with the second push rod such that the first and second push rods can make linear movement on the guide member, and a plurality of elastic members installed in the guide member to resiliently support the first and second push rods, respectively.

### BRIEF DESCRIPTION OF THE DRAWINGS

These and/or other aspects and advantages of the invention will become apparent and more readily appreciated from the following description of the embodiments, taken in conjunction with the accompanying drawings, of which:

FIG. 1 is a perspective view of a sliding apparatus in accordance with a first embodiment the present invention installed in a mobile phone;

FIG. 2 is a perspective view of a mobile phone having the sliding phone in accordance with the first embodiment of the present invention;

FIG. 3 is an exploded perspective view of the sliding apparatus;

FIG. 4 is an exploded perspective view of a pushing device of the sliding apparatus;

FIGS. 5, 6 and 7 are diagrams illustrating behaviors of the sliding apparatus; and

FIG. 8 is a cross-sectional view of a pushing device of a sliding apparatus in accordance with a second embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout the drawings. The embodiments are described below to explain the present invention by referring to the figures.

A sliding apparatus and a mobile phone having the same according to a first embodiment of the present invention will be described hereinafter.

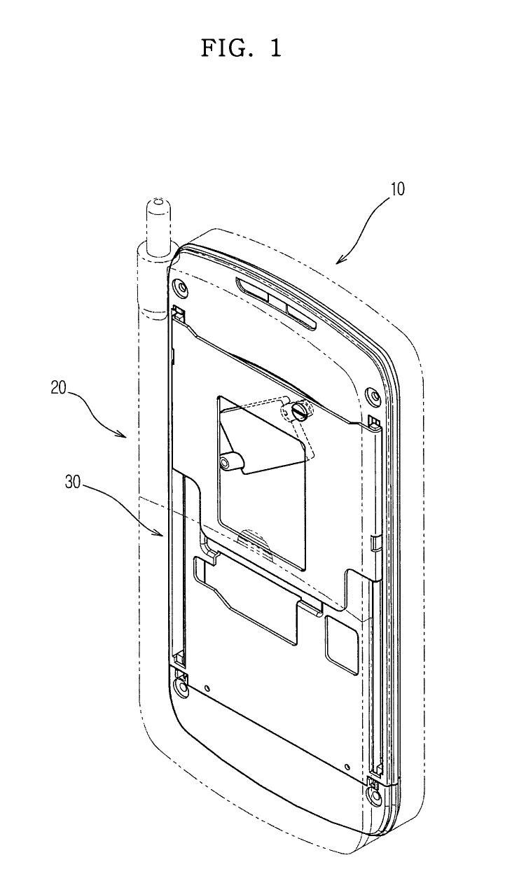

Referring to FIG. 1, the mobile phone having the sliding apparatus according to the invention comprises a first member 10 and a second member 20 formed to have a predetermined length, and coupled to slide with respect to each other via the sliding apparatus denoted by reference numeral 30 such that the first member 10 opens and closes a front side of the second member 20 via slide movement.

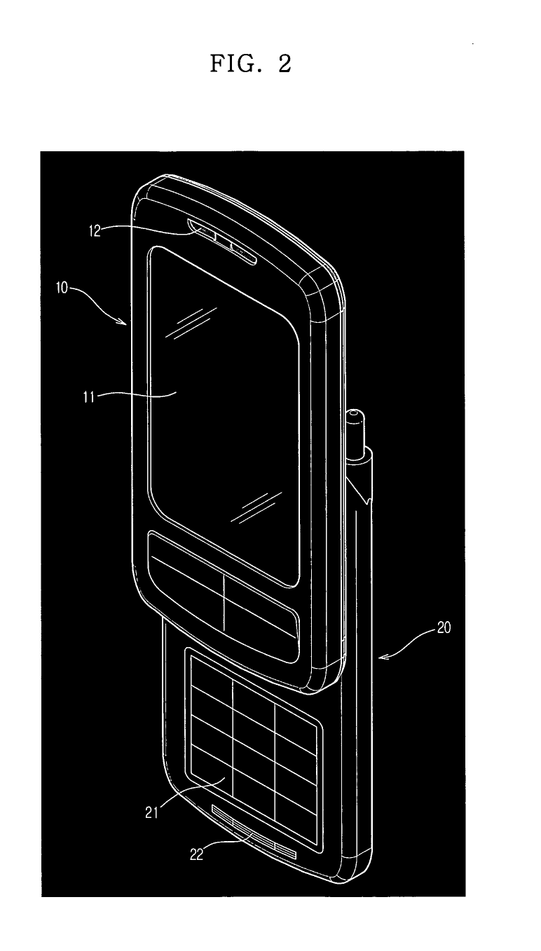

Referring to FIG. 2, the first member 10 is provided with a display window 11 comprising a liquid crystal panel and the like to display various kinds of information thereon, and with a receiver 12 having a speaker phone embedded therein to convert electrical signals into sounds. The second member 20 is provided with key pads 21 on which numbers and marks are printed to input various kinds of character information, and with a transmitter 22 having a microphone embedded therein to convert sounds into electric signals.

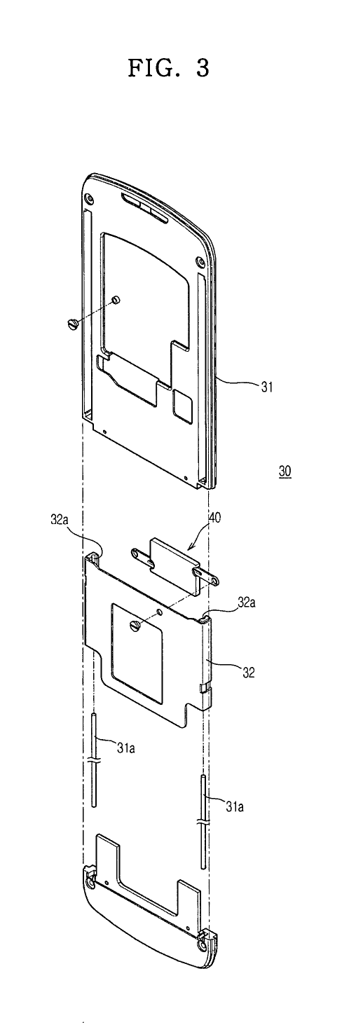

Referring to FIG. 3, the sliding apparatus 30 comprises a first slider 31 installed to the first member 10, a second slider 32 installed to the second member 20, and a pushing device 40 disposed between the first and second sliders 31 and 32 to move the second slider 32 towards one of both sides of the first slider 31 depending on a location of the second slider 32.

In order to allow the second slider 32 to be slidably coupled to the first slider 31, the second slider 32 is provided at either end with a second concave rail 32a which receives an associated end of the first slider 31 to slide therein, and the first slider 31 is provided at either end with a first rail 31a which is slidably received in the second slider 32a. In this embodiment, the first rail 31a has a higher strength and a smoother surface than those of the first slider 31. In this regard, rod-shaped members formed of a material having a low frictional coefficient are provided to both sides of the first slider 31 to constitute the first rails 31a.

The pushing device 40 is hingably coupled at one end to one side of the first slider 31 in a widthwise direction, and at the other end with the other side of the second slider 32 in the widthwise direction. The pushing device 40 is a device that is elastically deformed to have a shortened length by external force applied during movement of the second slider 32 by a user, and is then elastically recovered to an original length when the external force is released, thereby pushing the second slider 32 towards one of both sides of the first slider 31 in the longitudinal length.

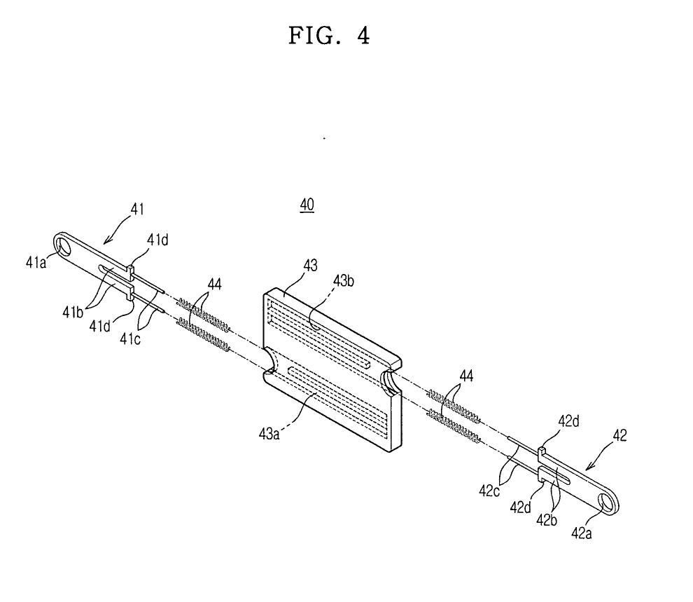

Referring to FIG. 4, the pushing device 40 comprises a pair of bar-shaped push rods 41 and 42, each having a predetermined length, a guide member 43 to receive the pair of push rods 41 and 42 to move linearly therein, and a plurality of elastic members 44 installed in the guide member 43 to resiliently support the first and second push rods 41 and 42, respectively, such that the first and second push rods 41 and 42 are protruded from the guide member 43 to an outside.

Thus, force applied to the sliding apparatus by the user is dispersed through the two push rods 41 and 42. Additionally, an elastic deformation degree of the elastic members 44 supporting the push rods 41 and 42 can be reduced to half of the case where only a single push rod 41 or 42 is used, so that deformation of the elastic members 44 is reduced. Furthermore, with the pair of push rods 41 and 42 installed slidably in the guide member 43, each of the push rods 41 and 42 contributes to variation in length of the pushing device 40, and allow the pushing device 40 to have a wide variation in length, thereby ensuring an increased travel distance of the second slider 32.

The pair of push rods 41 and 42 comprises a first push rod 41 which is hingably coupled at one end to the first member 10 while being slidably installed at the other end within the guide member 43, and a second push rod 42 which is hingably coupled at one end to the second member 20 while being slidably installed at the other end within the guide member 43. The first push rod 41 is provided at the one end with a first hinge 41a hingably coupled to the first slider 31, and the second push rod 42 is provided at the one end with a second hinge 42a hingably coupled to the second slider 32. According to this embodiment, both first and second hinges 41a and 42a have a hole shape.

In this embodiment, in order to effectively distribute force applied by the user, the other ends of the first and second push rods 41 and 42 installed within the guide member 43 are bifurcated into pairs of branch-rods 41b and 42b, respectively, such that each of the branch-rods 41b and 42b are supported by the elastic member 44. Accordingly, in this embodiment, a total of four elastic members 44 are installed within the guide member 43.

The guide member 43 is provided with a pair of concave guide parts 43a and 43b formed in a groove shape such that the first and second push rods 41 and 42 are slidably installed on the guide parts 43a and 43b. The pair of guide parts 43a and 43b comprises a first guide part 43a opened at one side of the guide member 43 to allow the first push rod 41 installed therein to linearly move into and from the one side of the guide member 43, and a second guide part 43b opened at the other side of the guide member 43 to allow the second push rod 42 installed therein to linearly move into and from the other side of the guide member 43. With this structure, when the first and second push rods 41 and 42 advance into the guide member 43, the whole length of the pushing device 40 is shortened. On the contrary, when the first and second push rods 41 and 42 are protruded from the guide member 43, the whole length of the pushing device 40 is extended.

The elastic members 44 are installed within the first and second guide parts 43a and 43b, respectively, and resiliently support the other sides of the first and second push rods 41 and 42 entering the first and second guide parts 43a and 43b, thereby exhibiting resilient force by which the first and second push rods 41 and 42 are protruded from the guide member 43. Each of the elastic members 44 is formed of a coil spring which is subjected to little deformation and breakage even after repetitious elastic deformation and recovery. The first and second push rods 41 and 42 have supports 41c and 42c which integrally extend from the other sides of the first and second push rods 41 and 42, and are placed into the elastic members 44 formed of the coil springs in order to stably maintain the state of the first and second push rods 41 and 42 being resiliently supported by the elastic members 44. According to this embodiment, the other sides of the first and second push rods 41 and 42 are bifurcated into branch-rods 41b and 42b from which the supports 41c and 42c extend. Thus, the total number of supports 41c and 42c is four.

In addition, in order to stably maintain the state of the first and second push rods 41 and 42 being installed in the guide member 43, the first and second guide parts 43a and 43b have mouths opened to have a relatively narrow width, and the first and second push rods 41 and 42 have protrusions 41d and 42d laterally protruding therefrom so as to be latched to the mouths of the first and second guide parts 43a and 43b, respectively. Accordingly, since the protrusions 41d and 42d of the first and second push rods 41 and 42 are latched to the mouths of the first and second guide parts 43a and 43b, respectively, it is possible to maintain the state wherein the first and second push rods 41 and 42 are installed in the guide member 43.

Operation of the sliding device according to the present invention will be described hereinafter with reference to the drawings.

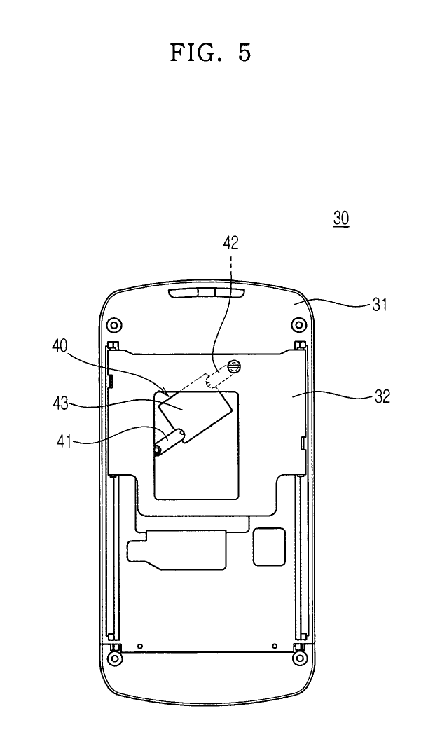

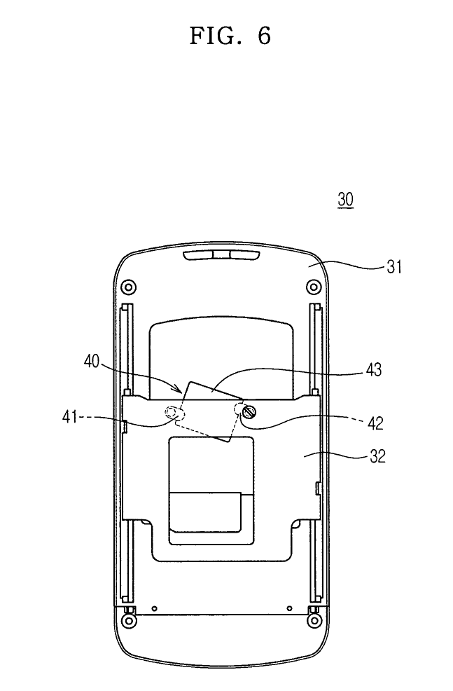

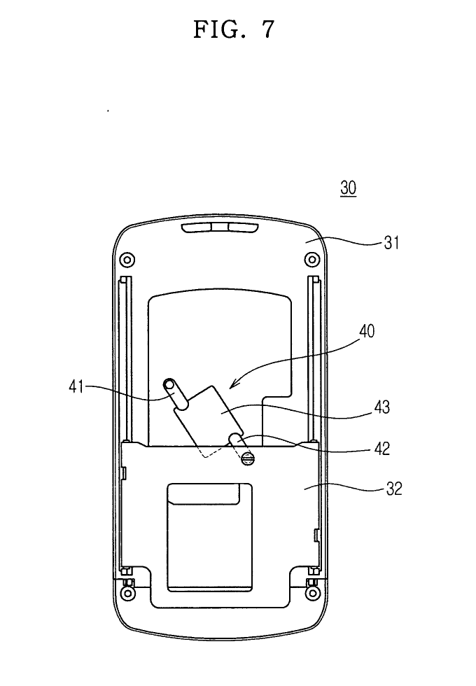

In a state of the front side of the second member 20 being covered with the first member 10, when the first member 10 having the first slider 31 installed thereon is forced to move upward by a user, as shown in FIG. 5, the second slider 32 is moved to a lower side of the first slider 31, and then, the elastic members 44 installed in the pushing device 40 are elastically deformed to force the first and second push rods 41 and 42 to be slowly received in the guide member 43, as shown in FIG. 6. When the first member 10 is moved a predetermined distance or more, the elastic members 44 are elastically recovered as shown in FIG. 7, and push the first and second push rods 41 and 42 to be protruded from the guide member 43, causing the second slider 32 to move to the lower side of the first slider 31. As a result, the front side of the second member 20 is opened. In this manner, the first member 10 and the second member 20 of the mobile phone can be semi-automatically opened and closed.

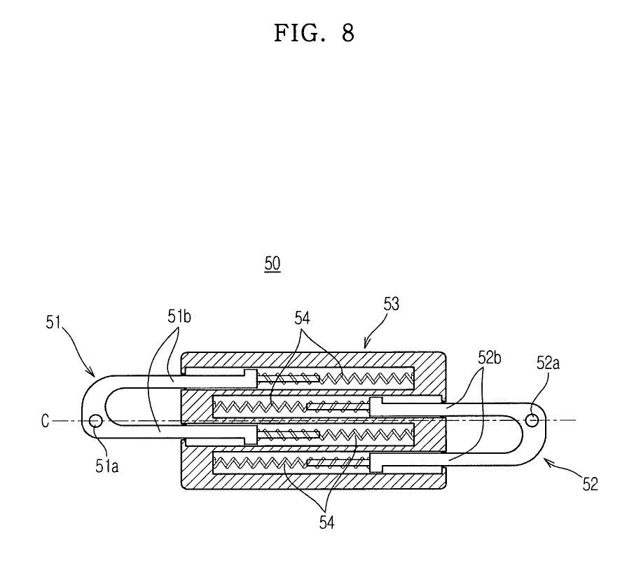

FIG. 8 shows a pushing device of a sliding apparatus according to a second embodiment of the present invention.

The pushing device, denoted by reference numeral 50, of the sliding apparatus of the second embodiment comprises a first push rod 51 hingably coupled at one end to a first slider 31, a second push rod 52 hingably coupled at one end to a second slider 32, and a guide member 53 in which the other sides of the first and second push rods 51 and 52 are slidably installed by a plurality of elastic members 54. Here, the pushing device 50 further comprises a first hinge part 51a provided to one end of the first push rod 51, and a second hinge part 52a provided to the second push rod 52, in which the first and second hinge parts 51a and 52a are substantially in symmetry about a center line C of the guide member 53.

In order to symmetrically dispose the first and second hinge parts 51a and 52a about the center line of the guide member 53 as described above, the first and second push rods 51 and 52 are bifurcated into two branch-rods 51b and 52b, respectively, such that the branch-rods 51b of the first push rod 51 alternate with the branch-rods 52b of the second push rod 52.

In this manner, when the first and second hinge parts 51a and 52a are symmetrical to each other about the center line of the guide member 53, a direction of external force applied to the pushing device 50 becomes the same as a sliding direction of the first and second push rods 51 and 52 so that the external force can be used to force the elastic members 54 to be elastically deformed more effectively, thereby allowing the first and second push rods 51 and 52 to be advanced or retreated more stably.

As apparent from the above description, in the sliding apparatus and the mobile phone having the same according to the present invention, external force applied to the sliding device by a user is dispersed to the plural elastic members via two push rods, thereby preventing deformation of the elastic members and degradation in performance caused by the deformation.

In addition, in the sliding apparatus and the mobile having the same according to the present invention, two push rods are slidably installed on the guide member, and enable the pushing device to have a wide variation in length thereof, thereby increasing a travel length of the second slider 32.

Although a few embodiments of the present invention have been shown and described, it would be appreciated by those skilled in the art that various modifications, additions and substitutions may be made in these embodiments without departing from the principle and spirit of the invention, the scope of which is defined in the claims and their equivalents.

What is claimed is:

1. A sliding apparatus, comprising a first slider having a predetermined length, a second slider installed slidably on the first slider to make linear movement in a longitudinal direction of the first slider, and a pushing device disposed between the first and second sliders to move the second slider towards one of both sides of the first slider depending on a location of the second slider,
wherein the pushing device comprises a first push rod hingably coupled at one end to one side of the first slider in a widthwise direction, a second push rod hingably coupled at one end to the other side of the second slider in the widthwise direction, a guide member, one end of which is installed with the first push rod, and the other end of which is installed with the second push rod such that the first and second push rods can make linear movement on the guide member, and a plurality of elastic members installed in the guide member to resiliently support the first and second push rods, respectively.

2. The sliding apparatus according to claim 1, wherein the guide member comprises a first guide part opened at one side of the guide member to allow the first push rod to be installed on the first guide part and linearly move along the one side of the guide member, and a second guide part opened at the other side of the guide member to allow the second push rod to be installed on the second guide part and linearly move on the other side of the guide member.

3. The sliding apparatus according to claim 2, wherein the first and second guide parts have mouths, each being opened to have a relatively narrow width, and the other sides of the first and second push rods inserted into the first and second guide parts have protrusions laterally protruding therefrom so as to be latched to the mouths of the first and second guide parts, respectively.

4. The sliding apparatus according to claim 2, wherein each of the elastic members is formed of a coil spring, and the other sides of the first and second push rods inserted into the first and second guide parts have supports extending therefrom so as to be placed into the elastic members formed of the coil spring.

5. The sliding apparatus according to claim 4, wherein the other sides of the first and second push rods are bifurcated into two branch-rods such that the supports are provided to the branch-rods, and allow the elastic members to be installed thereon, respectively.

6. The sliding apparatus according to claim 2, wherein the first push rod is provided at one end with a first hinge hingably coupled to the first slider, and the second push rod is provided at the other side with a second hinge hingably coupled to the second slider, the first hinge and the second hinge being disposed symmetrically on a line collinear with a central axis of the guide member.

7. The sliding apparatus according to claim 6, wherein the other sides of the first and second push rods are bifurcated into two branch-rods, respectively, such that the branch-rods of the first push rod alternate with the branch-rods of the second push rod.

8. A mobile phone, comprising a first member having a display window provided thereon, a second member having key pads arranged thereon, a first slider having a predetermined length and being installed on the first member, a second slider installed on the second member while being slidable along the first slider in a longitudinal direction of the first slider, and a pushing device disposed between the first and second sliders to move the second slider towards one of both sides of the first slider depending on a location of the second slider,
wherein the pushing device comprises a first push rod hingably coupled at one end to one side of the first slider in a widthwise direction, a second push rod hingably coupled at one end to the other side of the second slider in the widthwise direction, a guide member, one end of which is installed with the first push rod, and the other end of which is installed with the second push rod such that the first and second push rods can make linear movement on the guide member, and a plurality of elastic members installed in the guide member to resiliently support the first and second push rods, respectively.

9. The mobile phone according to claim 8, wherein the guide member comprises a first guide part opened at one side of the guide member to allow the first push rod to be installed on the first guide part and linearly move along the one side of the guide member, and a second guide part opened at the other side of the guide member to allow the second push rod to be installed on the second guide part and linearly move on the other side of the guide member.

10. The mobile phone according to claim 9, wherein the first and second guide parts have mouths, each being opened to have a relatively narrow width, and the other sides of the first and second push rods inserted into the first and second guide parts have protrusions laterally protruding therefrom so as to be latched to the mouths of the first and second guide parts, respectively.

11. The mobile phone according to claim 9, wherein each of the elastic members is formed of a coil spring, and the other sides of the first and second push rods inserted into the first and second guide parts have supports extending therefrom so as to be placed into the elastic members formed of the coil spring.

12. The mobile phone according to claim 11, wherein the other sides of the first and second push rods are bifurcated into two branch-rods such that the supports are provided to the branch-rods, and allow the elastic members to be installed thereon, respectively.

13. The mobile phone according to claim 9, wherein the first push rod is provided at one end with a first hinge hingably coupled to the first slider, and the second push rod is provided at the other side with a second hinge hingably coupled to the second slider, the first hinge and the second hinge being disposed symmetrically on a line collinear with a central axis of the guide member.

14. The mobile phone according to claim 13, wherein the other sides of the first and second push rods are bifurcated into two branch-rods, respectively, such that the branch-rods of the first push rod alternate with the branch-rods of the second push rod.
